(19) United States
(12) Patent Application Publication
(10) Pub. No.: US 2007/0156414 A1
(43) Pub. Date: Jul. 5, 2007

(54) Using Radio Frequency Identification (RFID) Technology to Assist Visually Impaired People and Others to Find Businesses, Services and Facilities

(76) Inventor: Mohammad Wasim Akhtar, San Jose, CA (US)

Correspondence Address: MOHAMMAD WASIM AKHTAR, 201 S. 4TH STREET, # 424, SAN JOSE, CA, 95112, US

(21) Appl. No.: 11/306,572

(22) Filed: Jan. 3, 2006

(51) Int. Cl. G06Q 99/00

(52) U.S. Cl. 705/1

(57) ABSTRACT

Businesses, services and facilities announce their presence using ultra-high frequency (UHF) radio frequency identification (RFID) tags that operate at 915 MHz and can be read as far as 25 feet, or microwave frequency RFID tags that operate at 2.45 GHz and can be read as far away as 100 feet. Visually impaired people and others equipped with RFID readers with text-to-speech converters and speech synthesizers or Braille panels can then discover such businesses, services and facilities when they come within the range of these RFID tags. Furthermore, visually impaired and others can use the same RFID readers to read the RFID tags from items on store shelves, etc. to locate items of interest.

### PREAMBLE

Even though most human beings have several senses that assist them in their daily lives (commonly known as the five senses of sight, sound, touch, smell and taste), our life is most dependent upon on our visual experience. We primarily use our eyesight to explore the world around us and discover new things by first seeing them. If a new road is constructed, we first see it, and then explore it to see where it leads. When a new shopping mall is constructed, we might hear about it through advertisements in newspapers, or on the radio or television. But, we then visit the mall to “see” what stores it has and to “see” if these stores contain any merchandise that might be of interest to us.

### THE ISSUES

The first issue is . . . How do visually impaired people discover businesses, services or facilities around them, whether they are old or new?

They know what exists because they have used a business, service or facilities in the past. Or, what someone might have told them about.

The second issue is . . . How do visually impaired people learn about new businesses, services or facilities?

Again, they have to rely on other human beings or advertisements to become knowledgeable about the new businesses, services, or facilities. Then they have to then find someone to take them to that place so that they can use it.

The same issues exist even for non-visually impaired people who might fail to discover a new business, service or facility because of its location or their own lack of attention.

### THE SOLUTION

At the present time, the use of radio frequency identification (RFID) technology has been successfully established to identify, track and locate a variety of merchandise and packaging. Following is a list of some of the patents that define the current state-of-art of the RFID technology:

| | |
|---|---|
| 6,172,609 | Lu et al |
| 6,451,154 | Grabau et al |
| 6,577,238 | Whitesmith et al |
| 6,923,572 | Kano |
| 6,944,424 | Heinrich et al |
| 20050242167 | Kario et al |

All components of the RFID technology are now available commercially at the retail level. This patent is targeted to further expand the innovative use of the currently available, and any future advances in the RFID technology, to benefit the visually impaired and others by announcing the presence of businesses, facilities and services through RFID tags.

Businesses, facilities and services (such as, shops, traffic lights, public restrooms, automated teller machines, etc.) can use the existing RFID technology to announce their presence. Visually impaired people and others equipped with RFID readers with text-to-speech converters can listen to the data on the RFID tags as they approach these businesses, facilitates and services, and know exactly what is near them.

Once inside a facility, the RFID readers can also read the RFID tags on the shelves of stores, for example. Or, provide more accurate details of the services available, such as the menu in a restaurant, and locations of automated teller machines and handicapped toilets.

The following drawings are part of this specification:

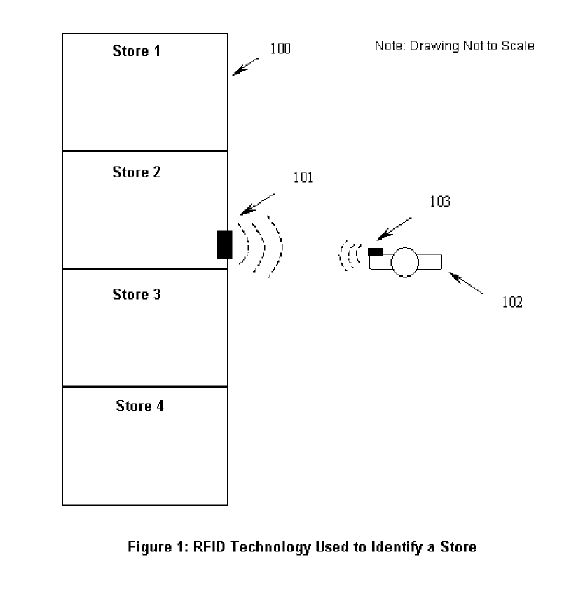

FIG. 1 is a schematic diagram of how RFID technology can be used to identify a store amongst several stores in a mall, shopping center or roadside shops.

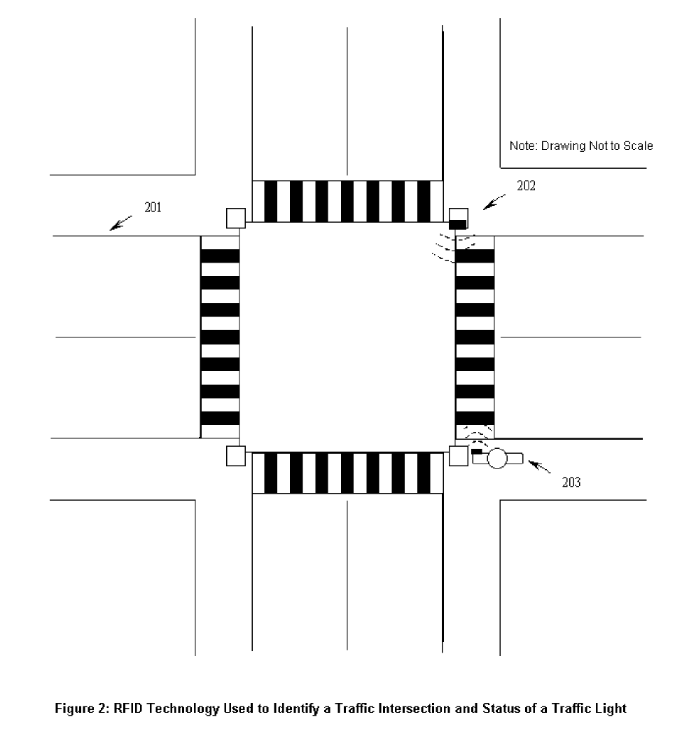

FIG. 2 is a schematic diagram of how RFID technology can be used to identify a street intersection and the current status of the pedestrian walk/wait signal.

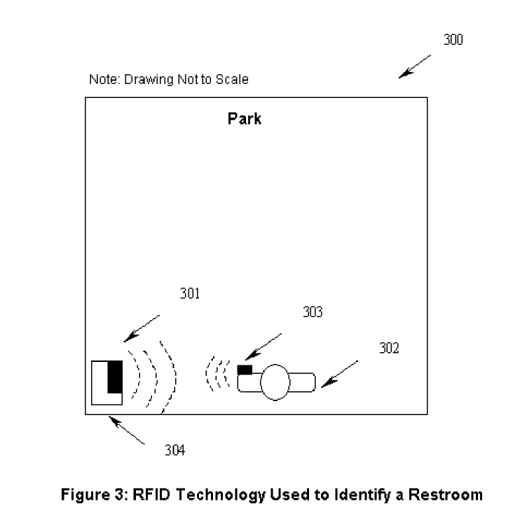

FIG. 3 is a schematic diagram of how RFID technology can be used to identify a restroom in a park.

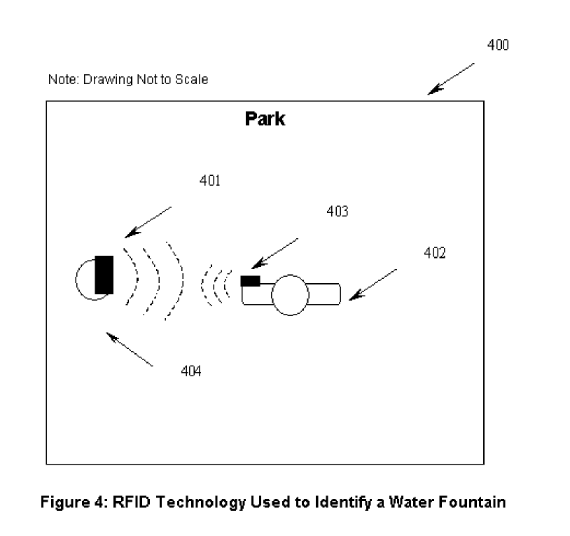

FIG. 4 is a schematic diagram of how RFID technology can be used to identify a restroom in a park.

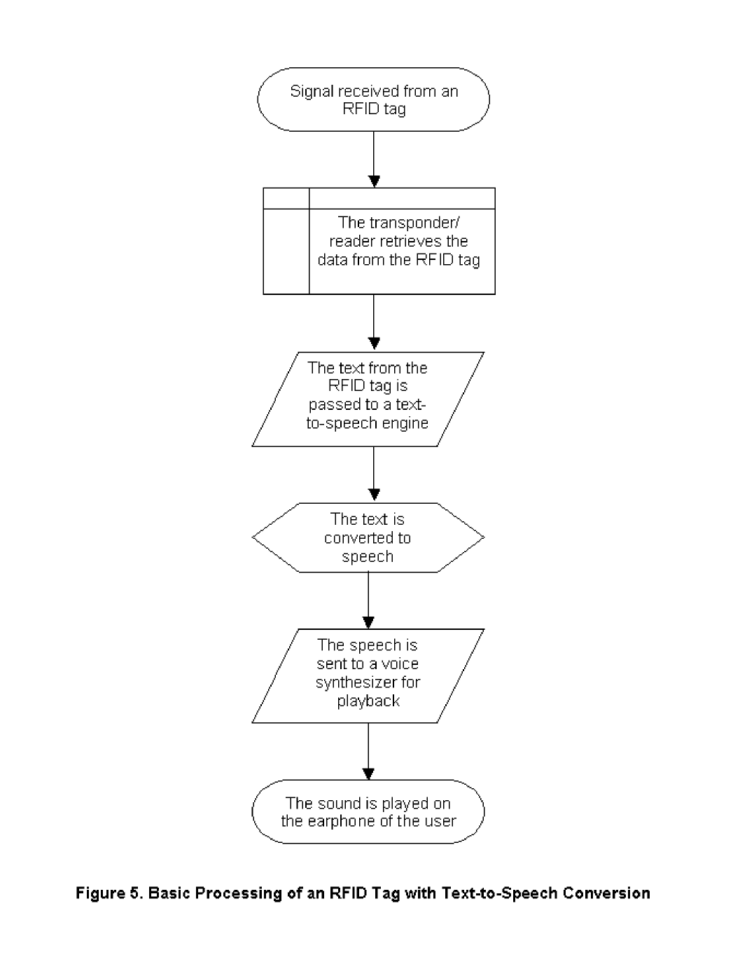

FIG. 5 is the flow diagram of how an RFID tag data is processed and announced to the user.

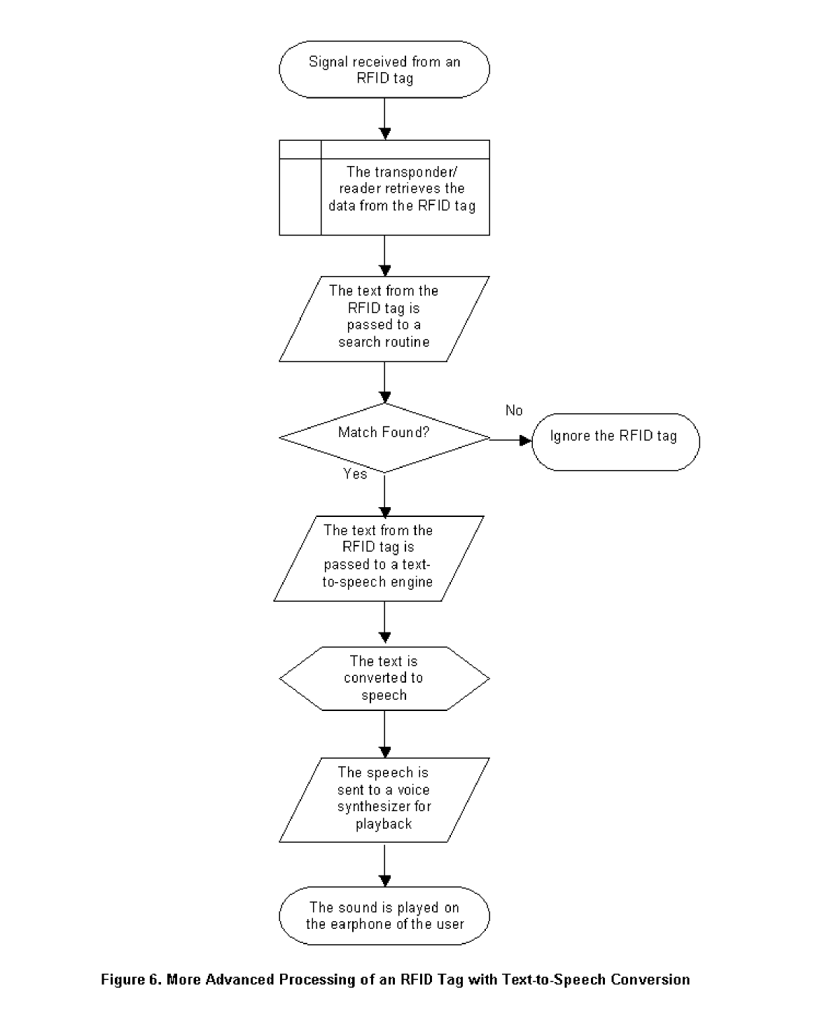

FIG. 6 is the flow diagram of how an RFID tag data is processed, then matched against user-entered search criteria, and if a match is found, then announce it to the user.

### DESCRIPTION

Generally speaking, RFID tags operate at the following four (4) major frequency ranges:

| | | |
|---|---|---|
| Frequency Type | Frequency Range | Reading Distance |

| | | | | |
|---|---|---|---|---|
| Low-Frequency | 125-148 | KHz | 3 | Feet |
| High-Frequency | 13.56 | MHz | 3 | Feet |
| Ultra-High Frequency | 915 | MHz | 25 | Feet |
| Microwave | 2.45 | GHz | 100 | feet |

For the purpose of this application, generally the ultra-high and microwave frequencies are expected to be used to allow longer distance detection.

FIG. 1 provides an overview of one RFID application to assist the visually impaired and others in identifying and locating a store in a shopping center or a mall.

Label 100 depicts a series of stores, amongst which Store 2 has an RFID tag 101 that relays information about the name of the store and a brief description of it's contents. There are a variety of RFID tag types that can be used for this purpose. It will be understood by those skilled in the art that the RFID tag 100 may be a RFID tag that is compatible with any suitable standard.

The RFID reader 103 scans the data stored on the RFID tag 101 when the person 102 comes within the range of the RFID tag 101. There are a variety of commercially available RFID readers that are suitable for this purpose. Their use will be understood by those skilled in the art that the RFID reader 103 may be a RFID reader which is compatible with suitable industry standards.

The scanned data is then converted into speech and played back on the earplug or headphone of the user 102. Alternatively, the scanned data is displayed on an LCD panel or a Braille device.

FIG. 2 provides an overview of how RFID technology can assist the visually impaired or others to identify a street corner and announce the status of the traffic light.

Label 201 identifies a typical street intersection that has traffic/pedestrian signals with RFID tags 202. When the pedestrian signal turns green (or to Walk), the RFID tag 102 announces the change of status so that anybody with an RFID reader on that street corner can read the change in condition and announce it to the person 203.

The technology used to implement this method will be understood by those skilled in the art.

FIG. 3 depicts the use of RFID technology to identify the location of a restroom to the visually impaired.

Label 300 identifies a park that has a public restroom 304 with facilities for the handicapped and visually impaired. That facility has an RFID tag 301 with information about the facility. When a visually impaired person 302 comes within the range of the RFID tag 301, the RFID reader 303 reads the data from the RFID tag 301 and alerts the person 302 about the availability of the facilities.

The technology used to implement this method will be understood by those skilled in the art.

FIG. 4 depicts the use of RFID technology to identify the location of a water fountain to the visually impaired.

Label 400 identifies a park that has a water fountain 404 with an RFID tag 401. When a visually impaired person 402 comes within the range of the RFID tag 401, the RFID reader 403 reads the data from the RFID tag 401 and alerts the person 402 about the availability of the water fountain.

The technology used to implement this method will be understood by those skilled in the art.

While the present innovative use as herein shown and described in detail is fully capable of attaining the above-described objects of the invention, it is to be understood that it is the presently preferred embodiment of the present innovative use and thus, is representative of the subject matter which is broadly contemplated by the present invention, that the scope of the present innovative use fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a system or method to address each and every problem sought to be solved by the present invention, for it is to be encompassed by the present claims.

What is claimed is:

1. A method of using radio frequency identification (RFID) technology to assist the visually impaired and others in locating, accessing and using businesses, services and facilities.

2. The method of claim 1, wherein such features can be offered anywhere at public or private facilities; such as, but not limited to, shopping centers, shopping malls, residential and office buildings, libraries, airports, theaters, hotels, restaurants, stadiums, bathrooms, water fountains, automated teller machines, among others.

3. The method of claim 1, wherein sending identification information by RFID tags to identify a business, service or facility.

4. The method of claim 1, wherein receiving identification information from a business, service or facility.

5. The method of claim 3, wherein the identification device is a radio frequency identification device.

6. The method of claim 4, wherein the receiving device is a radio frequency transponder, reader or receiver that is:
An independent unit with or without an earphone jack;
An independent unit with or without a display panel;
An independent unit with or without a Braille panel;
Connected to another device; such as, but not limited, to a computer, PDA or cell phone, with or without an earphone jack; or
Connected to another device; such as, but not limited to, a computer, PDA or cell phone, with or without Braille panel.

7. The method of claim 5, wherein the identification information contains details about businesses, services or facilities.

8. The method of claim 5, wherein the identification information contains details about items on store shelves.

9. The method of claim 6, wherein upon receiving the identification data, the reader converts the identification data into speech and plays back the contents for the user.

10. The method of claim 6, wherein upon receiving the identification, the reader converts the identification data into text and displays it on a panel or Braille display.

11. The method of claim 6, wherein upon receiving the identification, the reader matches the identification criteria (such as a Chinese restaurant) against the words and entries in the reader or an attached device to alert the user of the presence of a business, facility or service.
